(19) United States
(12) Patent Application Publication
(10) Pub. No.: US 2006/0009974 A1
(43) Pub. Date: Jan. 12, 2006

(54) Hands-free voice dialing for portable and remote devices

(75) Inventors: Jean-Claude Junqua, Santa Barbara, CA (US); Luca Rigazio, Santa Barbara, CA (US); Jia Lei, Beijing (CN)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Osaka (JP)

(21) Appl. No.: 10/888,916

(22) Filed: Jul. 9, 2004

(51) Int. Cl. G10L 15/18

(52) U.S. Cl. 704/257

(57) ABSTRACT

Dynamically constructed grammar-constraints and frequency or statistics-based constraints are used to constrain the speech recognizer and to optionally rescore the output to improve recognition accuracy. The recognition system is well adapted for hands-free operation of portable devices, such as for voice dialing operations.

### BACKGROUND OF THE INVENTION

The present invention relates generally to speech recognition systems. More particularly, the invention relates to an improved recognizer system that may be utilized in portable and remote devices to improve the recognition reliability. The disclosed embodiment features a recognition system for performing voice dialing. The invention is applicable to other systems as well.

Speech recognition systems are used today to allow users to operate devices and perform remote operations in a hands-free manner. For example, speech is now used in some cellular phones to perform voice dialing. In some such systems, the user preprograms certain frequently called numbers and assigns them a spoken name or label. By later speaking the name or label, the phone dials the assigned number. In more elaborate voice dialing systems, the user can speak the numeric digits of the number to be dialed and the recognition system will then convert the spoken utterances into digits which are then input into the dialing module of the phone. Similar hands-free operations may be performed in remote systems, where the user is speaking, such as over a telephone connection, to a remotely located speech recognition system which performs recognition on the user's utterances and attempts to carry out the user's instructions based on its recognition.

In practice, these conventional hands-free systems are prone to numerous recognition errors. The errors arise for a number of reasons. Background noise tends to greatly affect the reliability of recognition systems, as do other factors such as microphone placement (proximity to speaker) and quality of the communication channel. Recognition systems within cellular phones and other portable devices are particularly prone to recognition error, because these devices may be operated in very diverse environments, ranging from quiet rooms to noisy street corners or inside automotive vehicles.

Under difficult recognition conditions, some seemingly simple tasks can become quite difficult to perform. Dialing telephone numbers is an example. When dialing by voice, the user utters individual numbers, typically in a string lasting only a few seconds. A typical telephone number of seven to ten digits presents the recognizer with seven to ten opportunities to make a recognition error. Because each digit of a telephone number is critical, recognition errors of telephone numbers cannot be tolerated. Every digit must be recognized correctly, otherwise the wrong number will be dialed.

There have been a number of attempts to solve this problem. Many solutions seek to reduce recognition error rate by making the acoustic system more robust (noise canceling microphone, high-quality bit rate) or by adapting the recognition system to the particular user's voice and/or frequently encountered background noise conditions. Other systems seek to improve performance by presenting the user with the N-best output candidates, and requires the user to select one of the candidates. While these solutions do improve recognition, they have not successfully solved the problem. Other solutions work on the assumption that recognition errors are a fact of life. These systems provide the user with a graphical user interface through which the user can verify that the number he or she uttered was correctly recognized, and can make any corrections on the user interface when errors are present.

### SUMMARY OF THE INVENTION

The present invention takes a different approach. It applies grammar-based constraints and frequency and statistical-based constraints to constrain or control the recognizer in providing an output of the N-best recognition candidates. The grammar-based constraints and the frequency and statistical-based constraints are dynamically constructed as the user operates the device. The frequency/statistical-based constraints may be further used to rescore the N-best output, to which a confidence measure may be used to select the top candidate.

The improved hands-free system employs an automatic speech recognition system that is configured to apply grammar-based constraints and to produce decoding lattices and search those lattices to produce the N-best hypotheses. These hypotheses may then be subject to additional constraints. The system further includes a dynamic constraint builder or module that produces dynamic constraints and weighting probabilities for the automatic speech recognition system based on recent usage patterns. The system may also include a module that allows users to modify the automatically learned usage patterns, to change the system behavior and thus improve usability.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of an embodiment of the improved recognition system;

FIG. 2 is a block diagram of an embodiment of the improved recognition system;

FIG. 3 is an entity diagram illustrating examples of grammar-based constraints usable with the system of FIGS. 1 and 2;

FIG. 4 is an entity diagram illustrating frequency and/or statistics-based constraints, usable with the system of FIGS. 1 and 2;

FIG. 5 is a lattice diagram useful in understanding the operation of the improved recognition system.

### DETAILED DESCRIPTION OF THE PREFERRED EMBODIMENTS

The following description of the preferred embodiment(s) is merely exemplary in nature and is in no way intended to limit the invention, its application, or uses.

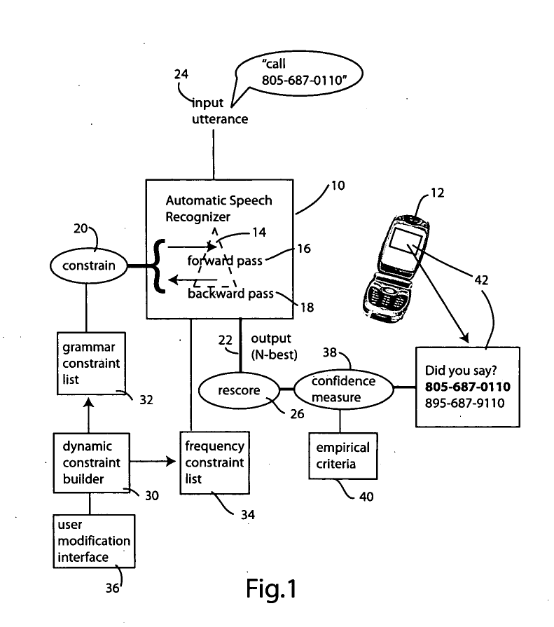

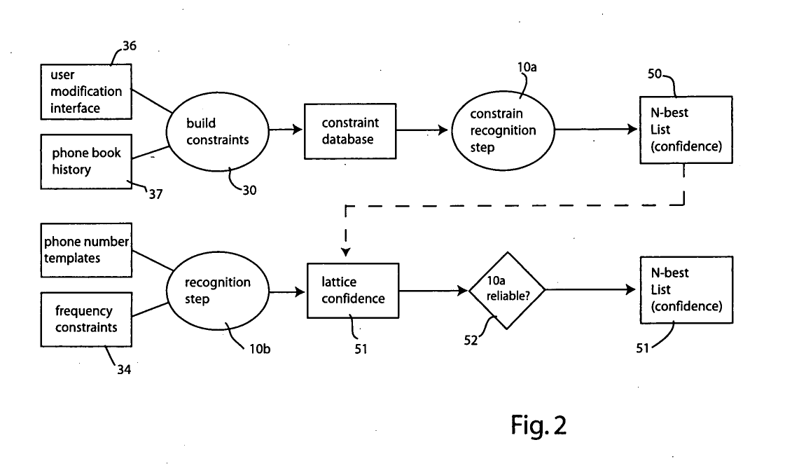

Referring to FIG. 1, the recognition system includes an automatic speech recognizer 10. The recognizer 10 may be embedded in a portable device such as cellular telephone 12. Alternatively, the recognizer 10 may be deployed on another system that the user communicates with by suitable means, such as by cellular telephone 12. As will be more fully explained below in connection with FIG. 2, the recognizer 10 may be conceptually viewed as two recognizers, operating in parallel or in series, each performing a different assigned function (one recognizer being tightly constrained and one being loosely constrained).

In the illustrated embodiment, the automatic speech recognizer 10 employs a decoding lattice that may be searched to produce an N-based hypothesis corresponding to a user's input utterance. In the illustrated embodiment the decoding lattice is shown diagrammatically at 14 and may be subject to both a forward pass algorithm 16 and a backward pass algorithm 18. A Viterbi algorithm or other suitable dynamic programming algorithm may be employed. Essentially, as will be more fully explained, the forward pass and backward pass algorithms are constrained as depicted diagrammatically by constrain operation 20 based on constraint information that is dynamically constructed as the user operates the system.

The output of recognizer 10, shown at 22, represents the N-best hypothesis corresponding to the user's input utterance shown at 24. As will be more fully explained, the output 22 may be rescored by the rescore operation 26, based on constraints that are generated dynamically as the user operates the system.

In the illustrated embodiment, two different types of constraints are employed: grammar-based constraints and frequency (or statistical)-based constraints. These constraints are constructed by the dynamic constraint builder 30 and stored in suitable data stores such as the grammar-constraint list 32 and the frequency-constraint list 34. In the illustrated embodiment a user modification interface 36 is provided, to allow the user to change the constraint data stored in the respective lists 32 and 34, to thereby alter the performance of the system.

If desired, a call history recording mechanism associated with a telephone may be used by the constraint builder to construct constraint data used in constraining the search algorithm. A call history recording mechanism is conventionally found on many cellular telephones today. Thus, the improved recognition system can make advantageous use of this existing mechanism, albeit for a new purpose, different from the conventional use in recording a history of calls received and/or placed.

The output of the rescoring operation 26 may be further operated upon by applying confidence measures as shown at 38. These confidence measures may be based on empirical criteria stored at 40.

Ultimately, the recognizer 10 processes the user's input utterance 24 and provides one or more output responses based on the constraints applied to the decoding lattice and based on any rescoring and application of confidence measures subsequently applied to the N-best output. The output response may be displayed on the display 42 of the portable device. Alternatively, the output response may be presented to the user audibly using synthesized speech, for example. In the illustrated embodiment, the display presents a portion of the N-best list, which has been sorted so that the most probable response is listed first and appears in bold print. Use of the display in this fashion is optional, as the operation of the recognition system produces very high accuracy such that in some applications it may not be necessary to display the recognition results to the user.

The dynamic constraint builder 30 is configured to monitor the usage patterns of the user, to record data in the respective lists 32 and 34 for subsequent use in constraining the recognition search algorithms and rescoring the output. There are many different usage patterns that might be used for constraining the algorithms and/or rescoring the output. For purposes of illustrating the principles of the invention, two different classes of constraints will be described here. Those skilled in the art will, of course, recognize that other types of constraints may also be used.

FIG. 2 illustrates an embodiment of the improved speech recognition system that employs two recognizers: a tightly constrained recognizer that performs constrained recognition at step 10a and a loosely constrained recognizer that performs loosely constrained recognition at step 10b. In the illustrated embodiment, these two recognizers run in parallel. Thus, the throughput of the system may be dictated by the slower of the two recognition processes (typically the loosely constrained process). In the alternative, the two recognizers may be run in series. When operated in series, the faster, tightly constrained recognizer is used first, with the slower, loosely constrained recognizer being used only if the confidence level of the tightly constrained recognizer is low (indicating that the uttered number does not match any of the previously stored or used numbers. Although two recognizers are discussed herein, it will be understood that these two recognizers are intended to convey that the functionality of two recognizers is provided. This functionality may be implemented by using two physically discrete recognizers, or they may be implemented using a single physical recognizer processor that utilizes two sets of data and/or control instructions, such that the single physical processor implements both recognizers.

As shown, the tightly constrained recognition step 10a uses a constraint database 32, which is populated by the operation of the dynamic constraint builder (shown in FIG. 2 by the “build constraints” operation 30 which the constraint builder performs). These constraints may be built by accessing sources of information such as a phone book or call history log. These sources, shown collectively at 37, may be specially derived for use by the constraint builder, or they may be derived from existing systems within the telephone (such as an existing call history log or preprogrammed phone book). As illustrated, the user modification interface 36 may serve as an input to the constraint builder, allowing the user to enter custom numbers or constraint information used to construct the constraint grammar used by the tightly constrained recognition process 10a. Essentially, the tightly constrained recognizer follows a lattice that is constructed based on previously encountered numbers, such as numbers from the call history log or phone book.

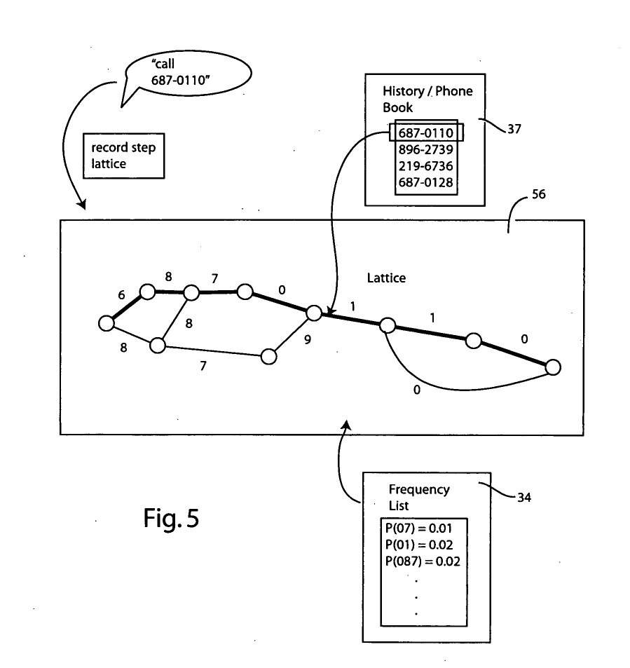

FIG. 5 illustrates an exemplary lattice or finite state network for the number 687-0110. The lattice, shown at 56 is traversed to recognize the number 687-0110, as illustrated in the path shown in bold lines. Other different paths, shown in lighter lines, are also illustrated. A lattice of this type would be constructed to represent all numbers in the history log or phone book. The lattice may be stored as data in the constraint database 32.

The tightly constrained recognizer preferably outputs an N-best list of recognition candidates, shown at 50. Preferably each of these recognition candidates has an associated confidence score. In this regard, the confidence score is the score generated by the recognizer to represent the likelihood or probability that the output string corresponds to the spoken utterance. Using the lattice illustrated in FIG. 5, a clearly uttered sequence under quiet ambient conditions of “687-0110” would result in a high recognition score. The same utterance under noisy conditions would probably produce a lower recognition score, even though the recognizer still identified the sequence as “687-0110.”

The loosely constrained recognizer 10b uses a different set of data to constrain recognition. Examples include phone number templates (which store the basic knowledge about how a phone number is configured—the number of digits, for example—but otherwise leave the recognizer unconstrained. Frequency constraints may also be employed. These store statistical knowledge about the frequency of certain numbers used. For example, if a user is located in a particular geographical area, it is likely that many of the numbers used will have the same area code. Examples of frequency or statistical-based constraints are further illustrated in FIG. 4. If desired, the recognition step 10b need not be constrained at all. As will be seen, the loosely constrained (or unconstrained) recognition step provides a backup for providing an N-best candidate list, in the event the tightly constrained recognizer is deemed unreliable by empirical criteria.

Operating without the lattice traversal-path constraints, recognition step 10b constructs an N-best list of candidates, each having confidence scores. Based on the implementation, the N-best list may be loosely constrained to correspond to phone number template grammars and/or other frequency or statistical constraints. The resulting N-best list may be selectively used as the N-best candidate list (shown at 51) if the results of the tightly constrained recognition step 10a are deemed to be unreliable. As illustrated, the lattice confidence associated with the N-best List 50 may be used at 51 as the input of the reliability assessment performed at decision point 52. The lattice confidence may involve a likelihood ratio between the high scoring hypotheses (paths of the graph or finite state network with the highest likelihood) and the background score that may be obtained as the average likelihood of all paths. Alternatively, a Universal Background Model (UBM), such as a Gaussian mixture model (GMM), to represent the likelihood of a general speech signal. In effect, as the user utters each number to traverse the lattice, the recognition step 10b applies loose constraints, such as the frequency constraint list 34 to ascertain the probability score of the recognition results. As seen in FIG. 5, the string “07” has a 0.01 probability of being uttered (based on historic data), whereas the string “01” has a 0.02 probability.

While the two-recognizers-in-parallel embodiment has been described in connection with FIG. 2, it will be understood that the recognizers may be operated in series. In such a recognizers-in-series embodiment the tightly constrained recognizer would provide its N-best list output in most cases; and the loosely constrained recognizer would be invoked only in those cases where the confidence score from the tightly constrained recognizer is low or deemed unreliable. The series embodiment has the advantage of operating more quickly under most conditions, as the tightly constrained recognition process typically involves fewer computational steps.

One advantage of the parallel embodiment is that the results of the two recognizers can be compared and the comparison used to determine which set of N-best outputs to use. Where there are few digit discrepancies between number strings within the two respective N-best lists, it is likely that the tightly constrained recognizer is producing reliable results. Thus the tightly constrained recognizer would be used to provide the N-best results. On the other hand, where the digits differ significantly, it is likely that the tightly constrained recognizer is not producing reliable results (perhaps because the uttered number string is a new sequence not previously stored in the history log. In such case, the loosely constrained recognizer would be used to supply the N-best output.

When using the parallel embodiment, another option is to allow the user to select which set of N-best lists to use. This would be done by providing the user with one or more string candidates from each list and allowing the user to select which is the correct or more reliable string.

As seen from the foregoing, the improved speech recognition system may make advantageous use of two broad classes of constraint information: grammar-based constraints and frequency or statistics-based constraints.

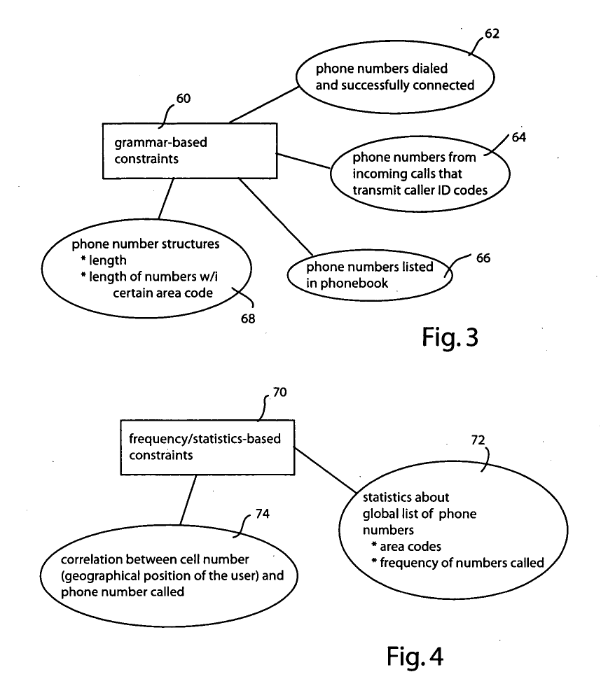

FIG. 3 illustrates what might be called grammar-based constraints. Shown in an entity diagram form, the grammar-based constraints 60 may include data such as the phone numbers dialed and successfully connected (shown at 62), phone numbers from incoming calls that transmit caller ID codes (shown at 64), phone numbers listed in a user's phone book (shown at 66) as well as other structural information about the syntax and grammar of phone numbers (shown at 68). Examples of such structures might include the length of the number or the length of the number within a certain area code. Because one important use of the invention is to improve the recognition of numbers for telephone dialing applications, the examples shown in FIG. 3 relate to phone numbers. Of course, it will be understood that the principles of the invention are readily extended to other recognition problems. Thus the entity diagram of FIG. 3 is merely intended to illustrate one possible application. Those skilled in the art would readily understand how to utilize these techniques to improve recognition in other applications. For example, in an information retrieval system numbers or other utterances might be used to code or tag information that the user will later want to retrieve by speaking the code or tag labels. Suitable grammar-based constraints could readily be developed for such an application.

In addition to grammar-based constraints, one preferred embodiment of the invention also utilizes frequency-based constraints or statistical-based constraints. These are illustrated in FIG. 4. FIG. 4 is an entity diagram giving some examples of frequency or statistics-based constraints. As with the grammar-based constraints, the examples illustrated in FIG. 4 are not intended to represent an exhaustive list. One form of frequency or statistics-based constraint, illustrated diagrammatically at 72, are statistics about a global list of phone numbers. Such statistics might include area codes, frequency of numbers called, and the like. Thus the entity at 72 generally represents statistics that can be largely generated by observing usage patterns of the numbers themselves. Other types of statistical data are also possible. Thus at entity 74 there is illustrated a correlation between cell number and the phone number called. In this regard, the geographical position of the user may be taken into account. Geographical user position could be determined, for example, from a GPS system (embedded within the portable device or accessible to the portable device) or it can be based on other information inherent to the operation of the device. In the case of a cellular phone, for example, the cellular infrastructure has information identifying which cell the portable device is currently communicating with. This information is used conventionally to hand off calls in progress, when a user moves from one location to another. This information might be utilized to supply statistical data of the type illustrated at 74 in FIG. 4.

In a presently preferred embodiments, such as the embodiments illustrated in FIGS. 1 and 2, the grammar-based constraints 60, particularly constraints 62, 64 and 66 (FIG. 3) are used by the constrain operation 20 to cause the recognizer 10 to produce a candidate with the hypothesis that the number dialed (uttered by the user) belongs to the list of constraints that have been built automatically and stored at 32. Other constraints, such as constraint 68 (FIG. 3) and constraint 72 (FIG. 4) may be used to produce a candidate from a loosely constrained recognition. In one embodiment, the candidate output by the loosely constrained recognizer can be weighted by the probability that a new number is called. A confidence measure is applied at 38 to determine which of the two candidates is output first: (1) the candidate output recognizer 10 from the list of known phone numbers; (2) the candidate output by the loosely constrained recognizer. When the user utters a new number (not reflected in the existing grammar of the tightly constrained recognizer) the loosely constrained recognizer may still be configured to accept the new number. In this way the system allows the user to call new numbers, while still getting the benefit of the tightly constrained system for recognizing previously called numbers. In this regard, it is estimated that users call existing number 95% of the time. The preferred embodiment capitalizes on this, by using the tightly constrained recognizer for these instances, while the loosely constrained recognizer keeps the system flexible to handle new numbers.

In the preceding discussion, different examples of recognizer constraints have been described, mainly constraints based on previously logged or acquired phone numbers (hard constraints) and constraints based on other grammar and statistical information (loose constraints). In a given application, either or both of these types of constraints may be employed, depending on the needs of the system and upon the usage pattern data being gathered. The confidence measure applied at 38 can be suitably developed to select which output to present first. The confidence measure will, in part, depend on the type of usage pattern data being utilized and on the nature of the loosely constrained recognizer employed. For example, one may utilize empirical criteria (illustrated at 40 in FIG. 1) such as the similarity between the digit strings from two recognizers or possibly the recognition likelihood score.

Many different embodiments are possible. For example, more than one candidate can be output by each recognizer. The system can also constrain the user to dial only a number that belongs to the list of phone numbers. In this case, only one recognizer would be needed.

The automatic speech recognition system of the invention capitalizes on the fact that most of the time the user will dial a phone number which belongs to the list of phone numbers built automatically by the dynamic constraint builder 30 (FIG. 1). In this case, the first candidate displayed will almost always be correct. Recognition rates of more than 99 percent are possible for selection out of a list of a few thousand phone numbers. In the case the user is dialing (by voice) a new phone number, the second candidate will still be available to the user, albeit with a lower degree of reliability. Recognition from the back-off network will only be about 90 percent accurate using today's technology. However, because the user will most often be interested in the first candidate, the overall reliability of the user interface will be much improved. For instance, even with the conservative assumption that the user is dialing from the list only 70 percent of the time, the overall reliability of the invention will be 0.3* 90%+0.7*99%=96.2%. This is approximately 6.2 percent higher than the initial reliability of 90 percent provided by the core recognition technology without utilizing the invention.

From the foregoing it will be appreciated that the invention provides a powerful and practical technology and user interface that improves the user experience in a context of hands-free voice dialing and other applications. In particular, the invention makes it possible to overcome the limitations of speech recognition in real environments. This is, in part, because speech recognition algorithms will always make some mistakes in real environments, and the present invention specifically allows for reducing the influence of such mistakes. The invention also enhances the user's experience by presenting the user with a user interface, listing the N-best candidate choices, in a manner that is most likely to be what the user intended. This allows the user to operate the device more easily in a hands-free manner.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An improved speech recognition system comprising:
an automatic speech recognizer that implements at least one constrainable search algorithm;
a dynamic constraint builder associated with a user device and configured to construct constraint data learned through observing operation of said user device;
said automatic speech recognizer being configured to access said constraint data and to constrain said search algorithm.

2. The system of claim 1 wherein said recognizer is configured to provide at least one recognition hypothesis and wherein said automatic speech recognizer is configured for communication with said user device and operable to provide said at least one recognition hypothesis to said user device.

3. The system of claim 1 wherein said constrainable search algorithm is a dynamic programming algorithm.

4. The system of claim 1 wherein said recognizer employs a decoding lattice having a forward pass and a backward pass and wherein said constraint data is used to constrain at lease one of said passes.

5. The system of claim 1 wherein said user device is a portable device.

6. The system of claim 1 wherein said user device is a cellular telephone.

7. The system of claim 1 wherein said user device is a telephone and wherein said dynamic constraint builder observes user operation of said telephone in dialing phone numbers.

8. The system of claim 1 wherein said user device is a telephone and wherein said dynamic constraint builder observes said telephone in receiving incoming calls.

9. The system of claim 8 wherein said dynamic constraint builder obtains caller ID codes from said incoming calls.

10. The system of claim 1 wherein said user device has an associated phonebook and wherein said dynamic constraint builder obtains data from said phonebook.

11. The system of claim 1 wherein said automatic speech recognizer is implemented on a system detached from said user device.

12. The system of claim 1 wherein said user device is a telephone and wherein said dynamic constraint builder gathers statistical data reflecting phone numbers called using said telephone.

13. The system of claim 12 wherein said statistical data reflect the frequency of numbers called.

14. The system of claim 12 wherein said statistical data reflect the frequency of area codes accessed.

15. The system of claim 1 wherein said user device is a telephone and wherein said dynamic constraint builder gathers statistical data reflecting the geographical position of said user device during its use.

16. The system of claim 1 wherein said recognizer outputs an N-best hypothesis.

17. The system of claim 16 wherein said constraint data are used to rescore said N-best hypothesis.

18. The system of claim 16 further comprising system for applying a confidence measure to selectively present said N-best hypothesis to the user.

19. The system of claim 18 wherein said user device includes a visual display and wherein said selective presentation of said N-best hypothesis is made to the user on said visual display.

20. The system of claim 18 wherein said user device includes an audible output and wherein said selective presentation of said N-best hypothesis is made to the user through synthesized speech over said audible output.

21. The system of claim 1 further comprising user modification interface cooperating with said dynamic constraint builder and adapted to selectively alter said constraint data in response to user manipulation.

22. The system of claim 1 wherein said user device is a telephone having a call history storage mechanism and wherein said dynamic constraint builder uses said call history storage mechanism to construct constraint data.

23. An improved speech recognition system comprising:
a first recognizer operating under a first set of constraints;
a second recognizer operating under a second set of constraints that differ from said first set;
a decision mechanism to select at least one most probable output candidate from at least one of said first and second recognizers.

24. The system of claim 23 wherein said first recognizer is a tightly constrained recognizer.

25. The system of claim 23 wherein said first set of constraints is derived from a call history log.

26. The system of claim 23 wherein said first set of constraints is derived from a digitally stored phone book.

27. The system of claim 23 wherein said second recognizer is a loosely constrained recognizer.

28. The system of claim 23 wherein said second set of constraints is derived from a predefined phone number grammar.

29. The system of claim 23 wherein said second set of constraints is derived from statistical information gathered during use of a telephone system.

30. The system of claim 23 wherein said decision mechanism employs an empirical criterion.

31. The system of claim 23 wherein said recognizers output confidence scores associated with output candidates and wherein said decision mechanism uses said confidence scores.

32. The system of claim 23 wherein said first and second recognizers are configured to operate in parallel.

33. The system of claim 23 wherein said first and second recognizers are configured to operate in series.
